(19) United States
(12) Patent Application Publication
(10) Pub. No.: US 2026/0064417 A1
(43) Pub. Date: Mar. 5, 2026

(54) PROCESSOR WITH DESCRIPTOR TABLE INSTRUCTION CIRCUITRY

(71) Applicant: Tenstorrent USA, Inc., Austin, TX (US)

(72) Inventors: Rakesh Shaji Lal, Hamilton (CA); Syed Gilani, Markham (CA); Alex Cejkov, Toronto (CA)

(21) Appl. No.: 19/296,927

(22) Filed: Aug. 11, 2025

Related U.S. Application Data
(60) Provisional application No. 63/689,199, filed on Aug. 30, 2024.

(51) Int. Cl. G06F 9/30; G06F 9/38; G06F 12/10

(52) U.S. Cl. CPC G06F 9/30098; G06F 9/3836; G06F 12/10; G06F 2212/65

(57) ABSTRACT

Systems and methods related to processors with descriptor table instruction circuitry are disclosed herein. A processor may be defined by an instruction set including an instruction. The processor may comprise: a set of data structures stored in a memory, a configuration register storing a set of characteristics of the set of data structures, and circuitry configured to execute an instruction having a syntax that includes an address in an address space of the data structures. Execution of the instruction may include using the address in the address space of the data structures and the information stored in the configuration register to calculate an address in the address space of the memory. This alleviates the burden of programming a computation in that the address space of the data structures is a step closer to the application level of the computation.

### CROSS REFERENCE TO RELATED APPLICATIONS

This application claims the benefit of U.S. Provisional Patent Application No. 63/689,199, filed August 30, 2024, which is incorporated by reference herein in its entirety for all purposes.

### BACKGROUND

An instruction set is a collection of commands that a processor can execute, serving as the interface between software and hardware. It defines the set of operations that a processor can perform, such as arithmetic calculations, data movement, and control flow operations. Each instruction in the set is a specific command that tells the processor to perform a particular task, utilizing its specialized circuitry designed to efficiently execute these operations. By providing a standardized way to interact with the processor, instruction sets allow programmers to write software that can leverage the hardware's capabilities to perform a wide range of tasks, from simple computations to complex algorithms. This abstraction layer enables flexibility and efficiency, making it possible for the same processor to run different types of software applications by interpreting the instructions they provide.

When programming for a processor, a key task often involves calculating the addresses of data elements within a given data structure to access and manipulate the necessary data for a computation. This process typically requires the programmer to manually write code that computes memory addresses based on the layout of the data structure, using arithmetic operations and pointer manipulation. Such address calculations must account for factors like the starting address of the structure, the size of each element, and any offsets due to alignment requirements. This can be cumbersome and error-prone, especially in complex data structures or when working with low-level languages like assembly. Mistakes in address calculations can lead to bugs, such as accessing the wrong memory location, causing unpredictable behavior or program crashes. The need for precise and careful address computation can significantly increase the complexity and time required to develop and maintain software, making the programmer’s job more challenging.

### SUMMARY

This disclosure relates to processors with descriptor table instruction circuitry. A processor may include descriptor table instruction circuitry that includes specialized circuitry configured to execute data manipulation instructions in an instruction set. The processor may comprise a set of data structures stored in a memory, a configuration register storing a set of characteristics of the set of data structures and storing information about the buffer storing the set of data structures, and circuitry configured to execute an instruction having a syntax that includes an address in an address space of the data structures.

The specialized circuitry allows a programmer to access data elements from within a data structure without having to code computations to calculate the address of those data elements, and without the computation layer of the processor needing to be used to calculate the address. Instead, the data elements can be referred to directly in a data manipulation instruction and the specialized circuitry can execute the data manipulation instruction to access the desired data elements transparently to the computation layer of the processor. Execution of the instruction includes using the address in the address space of the data structures and the configuration register to calculate an address in the address space of the memory. The use of descriptor table instruction circuitry alleviates the burden of programming a computation in that the address space of the data structures is a step closer to the application level of the computation, reducing complexity and potential for programming errors.

In specific embodiments of the invention, a processor defined by an instruction set including an instruction is provided. The processor comprises: a set of data structures stored in a memory, a configuration register storing a set of characteristics of the set of data structures, and circuitry configured to execute the instruction having a syntax that includes an address in an address space of the data structures. Execution of the instruction includes using the address in the address space of the data structures and the configuration register to calculate an address in an address space of the memory.

In specific embodiments of the invention, a method for executing an instruction, using a processor, is provided. The method comprises determining, based on a syntax of the instruction, an address in an address space of a data structure, the data structure being stored in a memory and the data structure being a part of a set of data structures. The method also comprises translating the address in the address space of the data structure into an address in an address space of the memory using information in a configuration register associated with the set of data structures. The execution of the instruction uses the address in the address space of the memory.

In specific embodiments of the invention, a processor, defined by an instruction set including an instruction, is provided. The processor comprises a memory organized into a set of buffers, each buffer storing a set of data structures. A set of characteristics are the same for each data structure in the set of data structures. The processor also comprises a configuration register. The configuration register stores a set of descriptors. Each descriptor in the set of descriptors corresponds to a buffer in the set of buffers and stores information indicative of the set of characteristics of the set of data structures of the corresponding buffer. The processor also comprises circuitry configured to execute the instruction, using the information, to thereby translate an address in an address space of the set of data structures into an address in an address space of the memory.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a memory organized into buffers storing data structures and corresponding descriptors in a configuration register in accordance with specific embodiments of the inventions disclosed herein.

FIG. 2 provides an example of a tile data structure with a corresponding descriptor in accordance with specific embodiments of the inventions disclosed herein.

FIG. 3 provides an example of a memory storing data structures and corresponding descriptors stored in a configuration register in accordance with specific embodiments of the inventions disclosed herein.

FIG. 4 provides an example of bit assignment in a descriptor in accordance with specific embodiments of the inventions disclosed herein.

FIG. 5 provides an example of converting an address in the address space of the data structure to an address in the address space of the memory in accordance with specific embodiments of the inventions disclosed herein.

FIG. 6 provides an example of data structures in a circular buffer in accordance with specific embodiments of the inventions disclosed herein.

FIG. 7 provides an example of a wrapping a data structure in a circular buffer in accordance with specific embodiments of the inventions disclosed herein.

FIG. 8 provides an example of a flowchart for operating a circular buffer in accordance with specific embodiments of the inventions disclosed herein.

FIG. 9 provides an example of a flowchart for operating a circular buffer using a data structure counter in accordance with specific embodiments of the inventions disclosed herein.

FIG. 10 provides an example of a method for executing an instruction using a descriptor in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for processors with descriptor table instruction circuitry in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

This disclosure relates to processor architectures and instruction sets for those processor architectures. In specific embodiments of the invention, specialized circuitry is provided that can execute data manipulation instructions in an instruction set which allow a programmer to access data elements from within a data structure without having to code computations to calculate the address of those data elements, and without the computation layer of the processor needing to be used to calculate the address. Instead, the data elements can be referred to directly in a data manipulation instruction and specialized circuitry can execute the data manipulation instruction to access the desired data elements transparently to the computation layer of the processor. The data manipulation instruction can be an instruction in the instruction set of the processor and can allow for reference to the data element addresses within the syntax of the instruction such that a programmer does not need to code the computations required to calculate the address of the data elements.

In specific embodiments of the invention, the specialized circuitry disclosed herein includes a set of registers that store a description of the data structures. In specific embodiments, the set of registers can be referred to as the descriptor table registers (which may be a type of configuration register). The descriptor table registers can be part of the global register space of the processor. The set of registers can have space for a specified number of descriptors. For example, the set of registers could have space for 32 descriptors. Each descriptor can be represented by an entry in the set of registers. For example, each descriptor can be represented by a 128-bit entry in the global register space.

The descriptors can store specific information about data structures that are used by the computation layer of the processing core. The descriptors can store specific information about data structures that are referenced by the instructions of the instruction set. For example, the descriptors can define a data type of the data elements in the data structure (e.g., floating point 32 bit, integer 8 bit, etc.). As another example, the descriptors can define a number of data structures defined by the descriptor. As another example, the descriptors can define a number of data elements stored in each data structure.

In specific embodiments, the descriptors can describe nested data structures that include multiple layers of data structures above the data elements. The descriptors can further include information about various aspects of the nested data structures. For example, the descriptors can include information about the sizes and compositions of each level of the nested data structures.

Specialized circuitry of the processing core can use the information from the descriptors to automatically calculate the address, in memory, of specific data elements from within the data structures. These computations can be done transparently to the code of the instruction set and the computation layer of the processing core. The specialized circuitry can be designed to access the required information regarding the data structures from the descriptor table registers and use the information with information provided in the instructions of the instruction set to compute the addresses of the referenced data structures. In specific embodiments, the specialized circuitry can also retrieve the data from the data structures or store data into the data structures.

In specific embodiments of the invention, the instructions can have various syntaxes to refer to the data structures in memory. The instructions can refer to different data elements by addresses that are in the address space of the data structure. The instructions can refer to specific levels of a nested data structure. The instructions can also refer to what should happen to the data elements at a given data structure. For example, the syntax of the instruction could refer to a type of the instruction (e.g., a write instruction or a read instruction) which will impact what is done with the data element or elements that are referenced by the instruction.

In specific embodiments of the invention, a processor defined by an instruction set is provided. The processor can be defined by the instruction set in that the processor includes specialized circuitry that is capable of executing the instruction set and the controller of the processor recognizes the operational codes of the instruction set. The processor can include a set of data structures stored in a memory. The memory can be the top-level memory that is used by the processor to conduct computations. The memory can be a scratch pad memory or a level one memory. The memory can be a random-access memory.

In specific embodiments, the memory can store a set of data structures. The set of data structures can be stored in memory at specific addresses in the memory in an address space of the memory. The data structures can be stored at multiple addresses across contiguous addresses in the address space of the memory or across disparate addresses in the address space of the memory. The data structures can include multiple data elements. The data elements can have different formats and can be stored at one or more addresses in the address space of the memory. The address space of the memory can include addresses which allow the processor to retrieve units of data from the memory or store units of data in the memory by providing those addresses to registers in the memory. The data structures can be nested data structures with different layers of data structures. For example, the data structure may include tensors which are made up of different vectors where both the tensors and vectors are data structures in a nested data structure.

In specific embodiments, the processor can include a set of configuration registers (e.g., descriptor table registers) storing a set of descriptors of the set of data structures. The set of descriptor table registers can have independent entries for each of the descriptors in the set of descriptors. The descriptors can describe the data structures stored in the memory. For example, the descriptor can store an identification of the data types of the data elements of the data structure, the number of data elements in the data structure, a starting address of the data structure, a limit address of the data structure, and other information to describe the data structure. In embodiments in which the data structure is a nested data structure, the values in the set of descriptor table registers can define the aforementioned information for each level of the nested data structure.

The values in the set of descriptor table registers can be defined by a programmer and set using instruction in the instruction set. Alternatively, or in combination, the values in the set of descriptor table registers can be set by a compiler that is used to generate instructions for the processor from source code that describes a complex computation that the processor will be used to execute.

In specific embodiments, the processor can include circuitry configured to execute an instruction having a syntax that includes an address in an address space of the data structures. The fact that the instruction can refer to the address space of the data structures can alleviate constraints placed on the programmer which are caused by the characteristics of the memory in which the data structures are stored or the manner in which the data structures happen to be stored in the memory at a given time. This can alleviate the burden of programming a computation in that the address space of the data structures is a step closer to the application level of the computation.

In specific embodiments of the invention, execution of the instruction can include using the address in the address space of the data structures and the set of descriptors to calculate an address in the address space of the memory. Since the instruction will refer to the data structure in the address space of the data structures, and the descriptor table registers include descriptions of the data structures, the processing core can execute the instruction by using this available information and custom circuitry to calculate the addresses of the data structures in the address space of the memory in order to access the data structures in memory for purposes of executing the instruction. For example, the instruction could be a read instruction and the data could be obtained from memory by first translating from the address space of the data structure to the address space of the memory and then retrieving the data from the address space.

In specific embodiments of the invention, the instructions may refer to specific descriptors that store a description of the data structure that is being accessed. For example, a tile A could have a format which is described by a descriptor 1 stored in the descriptor table register. Accordingly, the processor could use the identification of the descriptor to find that translation between the address space of tile A and the address space of the memory in which the data elements of tile A are stored.

In specific embodiments of the invention, the data structures could be tiles that store multiple data elements. The instructions of the instruction set could refer to tiles using names for the tiles. For example, a set of instructions could be: retrieve tile A, retrieve tile B, matrix multiply tile A and B, and store the result in tile C. The processor could be configured to take the address tile “A” and retrieve the tile from memory by translating that address into a set of addresses in the memory using the information in the set of descriptor table registers to compute the set of addresses in the address space of the memory.

In specific embodiments, the descriptors can include a start address and a limit address (e.g., a limit of the number of addresses allocated for the descriptor). In specific embodiments, the data structures can be nested data structures comprising tiles, faces, rows, and datums per row. In such embodiments, the instruction set of the processor can include different instructions which can refer to data elements in the data structure at various levels of the data structure. For example, the instruction set could include unpack or pack instructions, which retrieve or store multiple data elements at different levels of the instruction set. The pack or unpack instructions could take in a descriptor index and a tile index, and pack or unpack the entire tile using the description of the tile’s data structure which is stored at the portion of the descriptor data table identified by the descriptor index. The pack or pack instructions could take in a descriptor index, a tile index, and a face index, and pack or unpack the entire face using the description of the tile and face data structures which are stored at the portion of the descriptor data table identified by the descriptor index. The pack or pack instructions could take in a descriptor index, a tile index, a face index, and a row index and pack or unpack the entire row using the description of the tile, face, and row data structures which are stored at the portion of the descriptor data table identified by the descriptor index.

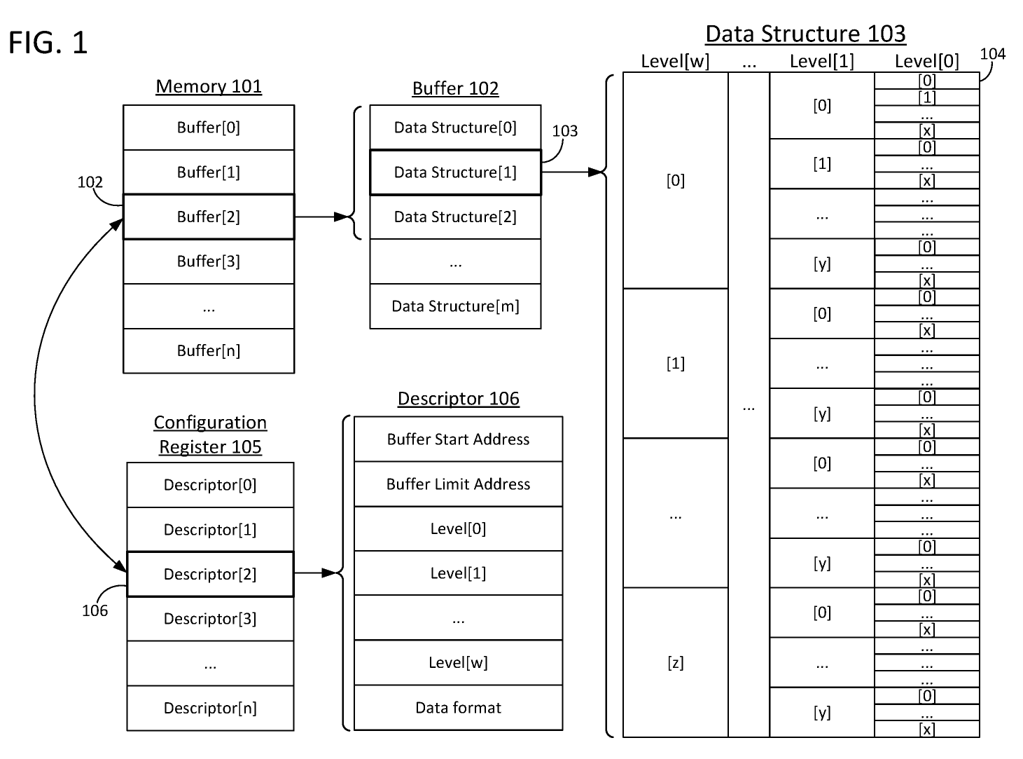

FIG. 1 provides an example of memory 101 organized into buffers with corresponding descriptors in configuration register 105 in accordance with specific embodiments of the inventions disclosed herein. Memory 101 is organized into (e.g., stores) n buffers; each buffer stores a set of data structures. The data structures may be nested data structures such as tensors or tiles. Different buffers may be different sizes and may store different quantities of data structures that have different sizes or datum types. Configuration register 105 stores descriptors that describe characteristics shared by the data structures stored by the corresponding buffer. Data structures in buffer[0] may be described by descriptor[0]; data structures in buffer[1] may be described by descriptor[1]; etc. Different descriptors may be different sizes. Entries in the descriptors may refer to different data types and data level sizes. Memory 101 may be the top-level memory that is used by a processor to conduct computations. Memory 101 may be a scratch pad memory or a level one (e.g., cache) memory. Memory 101 may be a random-access memory.

In specific embodiments, memory 101 may store a set of data structures (including data structure 103). The set of data structures can be stored in memory 101 at specific addresses in memory 101 in an address space of memory 101. The buffers storing data structures can be stored at multiple addresses across contiguous addresses in the address space of memory 101 or across disparate addresses in the address space of memory 101. The data structures can include multiple data elements (for example, data element 104).

In specific embodiments, the descriptors can describe nested data structures that include multiple layers of data structures above the data elements. The descriptors can further include information about various aspects (e.g., characteristics) of the nested data structures. For example, the descriptors can include information about the sizes and compositions of each level of the nested data structures. As illustrated, memory 101 holds buffer 102 (with index 2). Buffer 102 stores m data structures, including data structure 103 (with index 1). Data structure 103 is a nested data structure with w levels (e.g., layers). The first level (with index 0) has x elements (e.g., datum) per level 1. The second level (with index 1) has y elements (e.g., rows) per level 2. The pattern continues until the last level (with index w). As an example, the data structure may include tensors which are made up of different vectors where both the tensors and vectors are data structures in a nested data structure. As another example, the data structure may be a tile. A descriptor may allow a programmer to access the data structure without having to translate to an index of the data structure to a physical addresses by hand.

Configuration register 105 (e.g., a descriptor table register) may store a description of the data structures. Configuration register 105 can be part of the global register space of the processor. The set of registers can have space for a specified number (e.g., 32) of descriptors. Each descriptor can be represented by one or more entries in configuration register 105 or in additional registers not shown. In specific embodiments, different descriptors may be stored in different configuration registers. In specific embodiments, each descriptor can be represented by a 128-bit entry in the global register space. Configuration register 105 may have independent entries for each descriptors in the set of descriptors. For example, each descriptor in configuration register 105 may be a different length, may include different information, and may include different combinations of types of information.

As illustrated, configuration register 105 holds descriptor 106 (with index 2). Descriptor 106 corresponds to data structures in buffer 102. In the embodiment shown, descriptor 105 stores w + 4 entries, including a start address for buffer 102, a limit address for buffer 102, the sizes of levels [0] through [w] of data structure 103, and a data format of data structure 103. In the example of FIG. 1, level[0] has size x, level[1] has size y, and level[w] has size z. In specific embodiments, a descriptor may refrain from including a limit address for a buffer. In specific embodiments, the descriptor may instead include a quantity of data structures; a processor may calculate a limit address, if needed, based on the start address, the quantity of data structures, and the size of the data structures (e.g., based on level sizes). Buffer start address may be the start address of data structure[0] in the buffer. The buffer limit address may be the last address of data structure[m] in the buffer. Data structures with the same characteristics (e.g., number of levels, sizes of levels, data formats) may be stored in the same buffer and described by the same descriptor. Data structures in between the start address and the limit address may belong to that descriptor region because they are within that address reach. In specific embodiments, the limit address may ensure that software does not inadvertently go beyond the range of the buffer.

Within a memory space reserved for the data structures of a descriptor are multiple data structures which match the characteristics of the descriptor. In the illustrated case, data structures [0] through [m] of buffer 102 include w nested levels of the same data format (as specified by descriptor 106). Data structure 103 is made up of w levels and the levels may also be defined by descriptor 106. For example, descriptor 106 may say that level[0] has x quantity of elements, level [1] has y quantity of elements, and level[w] has z quantity of elements. Using the approaches disclosed herein, instructions can refer to the data in the address space of the data structures and specialized circuitry will translate the given indexes into the address space of memory 101.

The descriptors can store specific information about data structures that are used by the computation layer of the processing core. The descriptors can store specific information about data structures that are referenced by the instructions of the instruction set. For example, the descriptors can define a data format (e.g., data type) of the data elements in the data structure (e.g., floating point 32 bit, integer 8 bit, etc.). In specific embodiments, the descriptors can define a number of data structures defined by the descriptor. In specific embodiments, the descriptors can define a number of data elements stored in each data structure. The number of data elements stored in each data structure may be derived from information stored in the descriptor. For example, the level sizes stored in the descriptor may be multiplied together to calculate the size of the data structure (e.g., x times y times z). The number of data structures defined by a descriptor may be derived from information stored in the descriptor. For example, the start address, limit address, and level sizes may be used to calculate the number of data structures. The start address and the limit address may be used to calculate the size of the corresponding buffer; the size of the buffer may be divided by the size of the data structure to find the number of data structures in the buffer (and thus described by the descriptor). Specialized circuitry of the processing core can use the information from the descriptors to automatically calculate the address, in memory, of specific data elements from within the data structures. The specialized circuitry can be designed to access the required information regarding the data structures from the descriptor table registers and use the information with information provided in the instructions of the instruction set to compute the addresses of the referenced data structures.

The values in the descriptors (e.g., the set of descriptor table registers) can be defined by a programmer and set using instruction in the instruction set. Alternatively, or in combination, the values in the set of descriptor table registers can be set by a compiler that is used to generate instructions for the processor from source code that describes a complex computation that the processor will be used to execute.

In specific embodiments of the invention, execution of the instruction can include using the address in the address space of the data structures and the set of descriptors to calculate an address in the address space of the memory. Since the instruction may refer to the data structure in the address space of the data structures, and the descriptors include descriptions of the data structures, the processing core can execute the instruction by using this available information and custom circuitry to calculate the addresses of the data structures in the address space of the memory in order to access the data structures in memory for purposes of executing the instruction. For example, the instruction could be a read instruction and the data could be obtained from memory by first translating from the address space of the data structure to the address space of the memory and then retrieving the data from the address space.

In specific embodiments of the invention, the instructions may refer to specific descriptors that store a description of the data structure that is being accessed. For example, a data structure 103 could have a format which is described by descriptor 106 stored in the configuration register 105 (e.g., a descriptor table register). Accordingly, the processor could use the identification of descriptor 106 to find that translation between the address space of data structure 103 and the address space of memory 101 in which the data elements of data structure 103 are stored.

In specific embodiments of the invention, the data structures of buffer 102 (including data structure 103) could be tiles that store multiple data elements. The instructions of the instruction set could refer to tiles using names for the tiles. For example, a set of instructions could be: retrieve tile A, retrieve tile B, matrix multiply tile A and B, and store the result in tile C. The processor could be configured to take the address tile “A” and retrieve the tile from memory by translating that address into a set of addresses in the memory using the information in the set of descriptor table registers to compute the set of addresses in the address space of the memory.

In specific embodiments, the descriptors can include a start address and a limit address (e.g., a limit of the number of addresses allocated for the descriptor). In specific embodiments, the data structures can be nested data structures comprising tiles, faces, rows, and datums. In such embodiments, the instruction set of the processor can include different instructions which can refer to data elements in the data structure at various levels of the data structure. For example, the instruction set could include unpack or pack instructions, which retrieve or store multiple data elements at different levels of the instruction set. The pack or unpack instructions could take in a descriptor index and a tile index, and pack or unpack the entire tile using the description of the tile’s data structure which is stored at the portion of the descriptor data table identified by the descriptor index. The pack or pack instructions could take in a descriptor index, a tile index, and a face index, and pack or unpack the entire face using the description of the tile and face data structures which are stored at the portion of the descriptor data table identified by the descriptor index. The pack or pack instructions could take in a descriptor index, a tile index, a face index, and a row index and pack or unpack the entire row using the description of the tile, face, and row data structures which are stored at the portion of the descriptor data table identified by the descriptor index.

The system of FIG. 1 allows a programmer to access data elements from within a data structure without having to code computations to calculate the address of those data elements and without the computation layer of the processor needing to be used to calculate the address. In FIG. 1, the data elements can be referred to directly in a data manipulation instruction and specialized circuitry can execute the data manipulation instruction to access the desired data elements transparently to the computation layer of the processor. The data manipulation instruction can be an instruction in the instruction set of the processor and can allow for reference to the data element addresses within the syntax of the instruction such that a programmer does not need to code the computations required to calculate the address of the data elements.

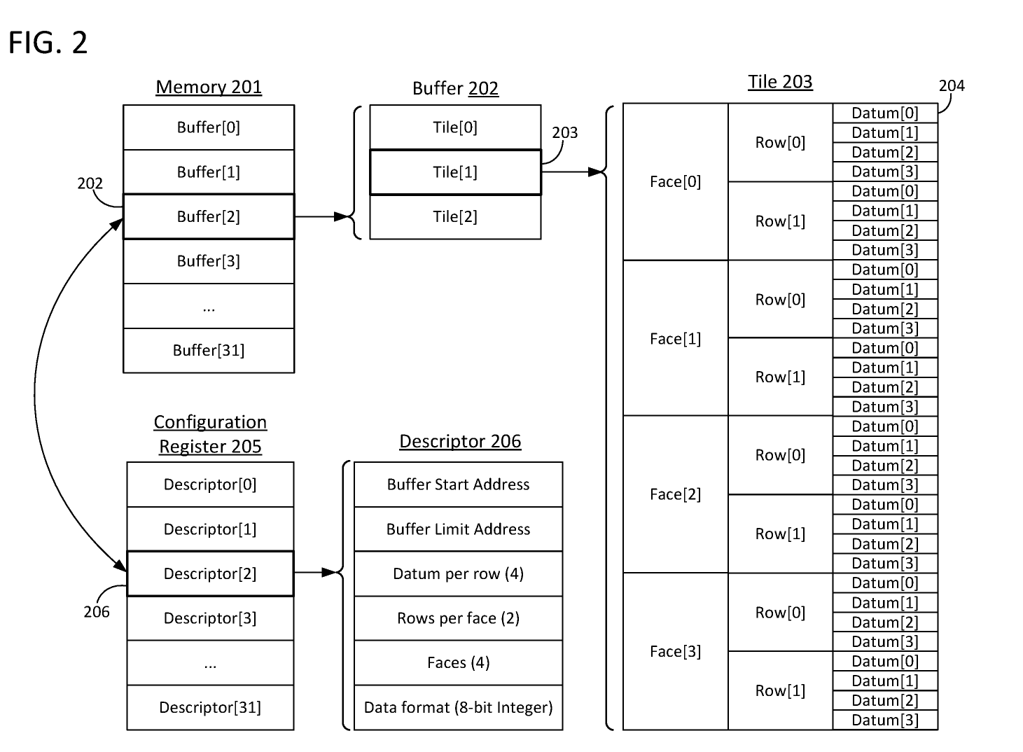

FIG. 2 provides an example of a tile data structure with a corresponding descriptor in accordance with specific embodiments of the inventions disclosed herein. Memory 201 is organized into (e.g., stores) 32 buffers; each buffer stores a set of data structures. In specific embodiments, each buffer may be a circular buffer. In the example of FIG. 2, the data structures are tiles. Configuration register 205 stores descriptors that describe characteristics shared by the tiles stored by the corresponding buffer. Memory 201 may be a level one (L1) cache memory. A processor may include memory 201 and configuration register 205. A data tile may be a data structure that is stored in memory and referenced by the application code.

Configuration register 205 (e.g., a descriptor table register) may store a descriptors which describe shared characteristics of the corresponding tiles. In the example of FIG. 2, configuration register 205 stores 32 descriptors. Each descriptor can be represented by a 128-bit entry in the global register space. Configuration register 205 may represent a conglomeration of multiple different configuration registers. That is, one or more descriptors may be stored in distinct configuration registers or all descriptors may be stored in the same configuration register. In specific embodiments, memory 201 may store a set of tiles (including tile 203). The tiles can be stored in memory 201 at specific addresses in memory 201 in an address space of memory 201. The tiles can include multiple data elements (for example, datum 204).

As illustrated, memory 201 holds buffer 202 (with index 2). Buffer 202 stores three tiles, including tile 203 (with index 1). Tile 203 has three levels (e.g., layers): datum, rows and faces. Tile 203 includes four datum per row, two rows per face, and four faces. These element quantities are exemplary only, as a tile may have any ratio of different levels. As tiles are nested data structures, the descriptors can include information about various aspects (e.g., characteristics) of the nested data structures. For example, descriptor 206 can include information indicative of a quantity of elements in tile 203 by including information about a quantity of elements in each level of tile 203. Descriptor 206 stores the sizes of each level of tile 203 as well as a start address for buffer 202 and a data format of datums of tile 203. The start address for buffer 202 may correspond to the start address of the set of tiles, as buffer 202 stores the set of tiles. In the example of FIG. 2, the data format is an 8-bit integer. In specific embodiments, descriptor 206 may also store a limit address of buffer 202 in the address space of memory 201. Descriptor 206 describes the characteristics of each tile within buffer 202. That is, each tile in buffer 202 has the same level sizes (four datum per row, two rows per face, and four faces) and the same data format (8-bit integer). Each tile in the set of tiles has the same quantity of elements at each nested level as the other tiles in the set of tiles. Configuration register 205 stores an indicator of the quantity of elements at each nested level for each nested level of the set of tiles. For example, descriptor 206 indicates the quantity of datums (4), rows (2), and faces (4) for each tile stored in buffer 202.

Instructions can refer to the data in the address space of the tiles and specialized circuitry will translate the given indexes into the address space of memory 201. In specific embodiments, the instructions of an instruction set could refer to tiles using names for the tiles. For example, a set of instructions could be: retrieve tile A, retrieve tile B, matrix multiply tile A and B, and store the result in tile C. Tile A could be tile[1] in buffer 202, tile B could be tile[2] in buffer 202, and tile C could be tile[5] in buffer[5] (not shown). The processor could be configured to take the address tile “A” and retrieve the tile from memory by translating that address into a set of addresses in the memory using the information in the configuration register to compute the set of addresses in the address space of the memory.

In specific embodiments, the instruction set of the processor can include different instructions which can refer to data elements in the tiles at various levels of the tile. For example, the instruction set could include unpack or pack instructions, which retrieve or store multiple data elements at different levels of the instruction set. The pack or unpack instructions could take in a descriptor index and a tile index, and pack or unpack the entire tile using the description of the tile’s data structure which is stored at corresponding descriptor. The pack or pack instructions could take in a descriptor index, a tile index, and a face index, and pack or unpack the entire face using the description of the tile and face data structures which are stored at the corresponding descriptor. The pack or pack instructions could take in a descriptor index, a tile index, a face index, and a row index and pack or unpack the entire row using the description of the tile, face, and row data structures which are stored at the corresponding descriptor.

The system of FIG. 2 allows a programmer to access data elements (e.g., datum) from within a tile without having to code computations to calculate the address of those data elements and without the computation layer of the processor needing to be used to calculate the address. In FIG. 2, the data elements can be referred to directly in an instruction and specialized circuitry can execute the instruction to access the desired data elements transparently to the computation layer of the processor. The instruction can be an instruction in the instruction set of the processor and can allow for reference to the data element addresses within the syntax of the instruction such that a programmer does not need to code the computations required to calculate the address of the data elements. The instruction may have a syntax that includes an address in an address space of the tiles. The execution of the instruction may include using the address in the address space of the tile and the configuration register (e.g., the information stored in the corresponding descriptor in the configuration register) to calculate an address in an address space of the memory.

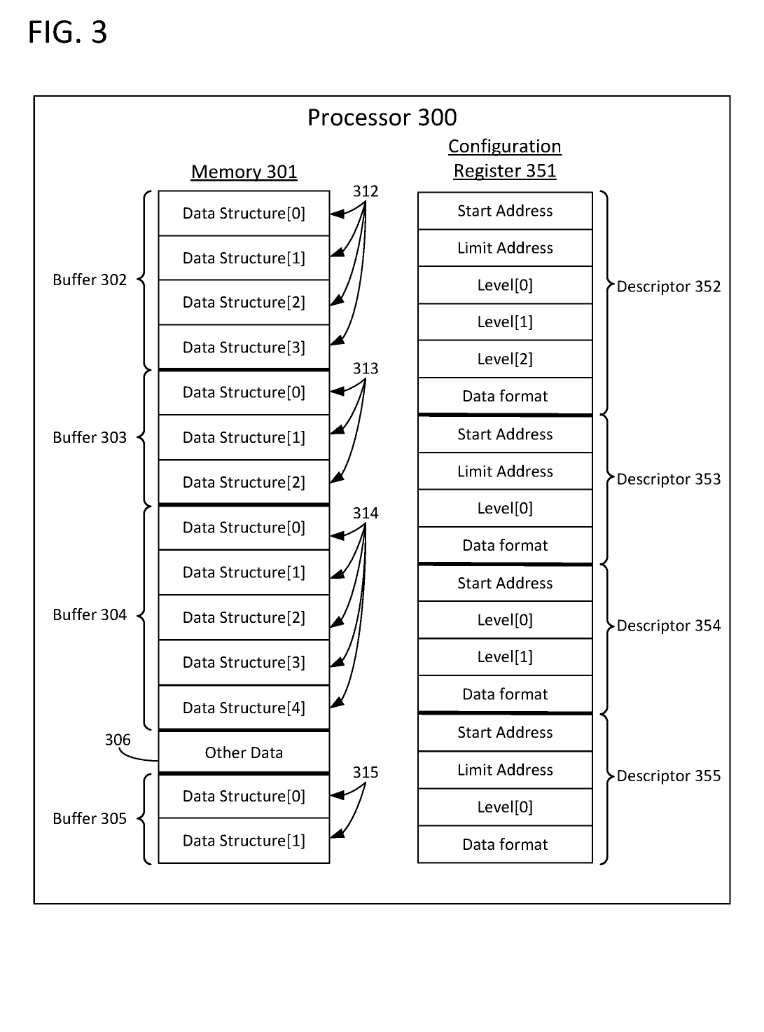

FIG. 3 provides an example of processor 300 with memory 301 storing data structures and with configuration register 351 storing descriptors that correspond to the data structures in accordance with specific embodiments of the inventions disclosed herein. Processor 300 may be defined by an instruction set including an instruction. Memory 301 may be organized into a set of buffers including buffers 302, 303, 304, and 305. Each buffer 302, 303, 304, and 305 may store a set of data structures 312, 313, 314, and 315 respectively. Each descriptor 352, 353, 534, and 535 stored in configuration register 351 may correspond to buffers 302, 303, 304, and 305 respectively and may store information indicative of the set of characteristics of the set of data structures of the corresponding buffer. Buffers may not be the same size as other buffers. Descriptors may not be the same size as other descriptors. Descriptors may be independent of each other. Each buffer may be associated with a descriptor which may indicate to the hardware what it needs to know about that buffer so that processor 300 can execute instructions using that buffer. Memory 301 may be a level one cache memory. Configuration register 351 may be separate from memory 301 such that it is not a level one cache memory.

A set of characteristics are the same for each data structure in the set of data structures. For example, data structure[0], data structure[1], data structure[2], and data structure[3] of buffer 302 share a set of characteristics. Data structure[0], data structure[1], and data structure[2], of buffer 303 share a set of characteristics that are different than the set of characteristics shared by set of data structures 312 of buffer 302. The set of characteristics for a buffer is stored in the corresponding descriptor.

Each set of data structures 312, 313, 314, and 315 stored in memory 301 may have a unique combination of characteristics relative to the other sets of data structures, as described by the respective descriptor 352, 353, 354, and 355. The set of characteristics may include a data format of datums in each data structure in the set of data structures, a quantity of nested levels in each data structure in the set of data structures, and a size of each nested level in each data structure in the set of data structures.

For example, descriptor 352 describes set of data structures 312 as each being nested data structures with three levels (level[0], level[1], and level[2]). Descriptor 352 stores information indicative of the sizes of each of these levels as well as a data format of the datum level of each data structure (which is the same format for the datum of each data structure in the set of data structures). Descriptor 352 may also store the start address for buffer 302 in the address space of the memory 301. In specific embodiments, descriptor 352 may also store the limit address for buffer 302 in the address space of the memory 301. In specific embodiments, data structure 312 may be a tile having a level[0] size of 16 (16 datums per row), a level[1] size of 16 (16 rows per face), and a level[2] size of 4 (4 faces).

Each descriptor may store the characteristics of the corresponding set of data structures. Descriptor 353 describes set of data structures 313 as each having with a single level (e.g., data structure 313 is not nested). Descriptor 353 stores information indicative of the size of this level as well as a data format of the level of each data structure (which is the same format for the datum of each data structure in the set of data structures). Descriptor 353 may also store the start address for buffer 303 in the address space of the memory 301. In specific embodiments, descriptor 353 may also store the limit address for buffer 303 in the address space of the memory 301.

Both descriptor 353 and descriptor 355 store a buffer start address, a limit address, a level size, and a data format of a data structure with a single level. However, descriptors 353 and 355 may have different buffer start addresses and a different limit addresses, as each refers to different buffers (buffers 303 and 305 respectively). Set of data structures 313 corresponds to a first address range in memory 301 while set of data structures 315 corresponds to a second address range in memory 301; these address ranges may be different sizes. Additionally, descriptors 353 and 355 may store information indicative of distinct characteristics of data set 313 compared to data set 315 such as different level sizes and/or different data formats. For example, descriptor 353 may have a level size of 32 and an 8-bit integer data format while descriptor 355 may have a level size of 128 and a 32-bit floating point data format.

In specific embodiments of the invention, the instructions can have various syntaxes to refer to the data structures in memory. The instructions can refer to different data elements by addresses that are in the address space of the data structure. The instructions can refer to specific levels of a nested data structure. The instructions can also refer to what should happen to the data elements at a given data structure. For example, the syntax of the instruction could refer to a type of the instruction (e.g., a write instruction, a read instruction, a pack instruction, or an unpack instruction) which will impact what is done with the data element or elements that are referenced by the instruction. Circuitry of processor 300 may be configured to execute the instruction, using information stored in the descriptor (e.g., descriptor 352), to thereby translate (e.g., calculate) an address in an address space of the set of data structures (e.g., set of data structures 312) into an address in an address space of memory 301. The circuitry may be further configured to execute a second instruction having a syntax that includes an address in an address space of a second set of data structures (e.g., set of data structures 314). Execution of the second instruction may include using the address in the address space of the second set of data structures and the second set of characteristics (e.g., as stored by descriptor 354) to calculate a second address in the address space of memory 301.

The data structures can be stored at multiple addresses across contiguous addresses in the address space of memory 301 or across disparate addresses in the address space of memory 301. For example, other data 306 may not be part of a data structure but may still be stored in memory 301. Set of data structures 314 may not be contiguous with set of data structures 315. As other data 306 does not relate to data structures, there may not be a corresponding descriptor for the address range of other data 306.

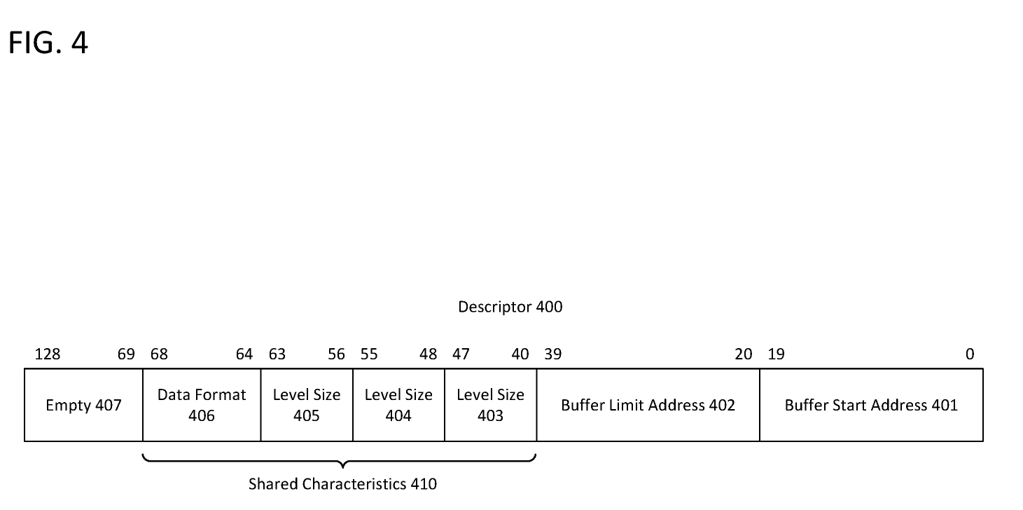

FIG. 4 provides an example of bit assignment in descriptor 400 in accordance with specific embodiments of the inventions disclosed herein. Descriptors 400 may describe characteristics of a set of data structures stored in a buffer. The characteristics may include buffer start address 401, buffer limit address 402, level sizes of the data structure, and data format 406 of the data structure. Buffer start address 401 and buffer limit address 402 may be in the address space of the memory that stores the data structure. Descriptor 400 may be a 128-bit entry in the global register space. Descriptor 400 may not take up the entire 128-bit entry with informational bits. For example, section 407 may be empty.

In the example of FIG. 4, descriptor 400 describes a set of data structures with three levels. In specific embodiments, the set of data structures may be tiles such that first level size 403 may refer to a number of datums per row, level size 404 may refer to a number of rows per face, and level size 405 may refer to a number of faces in the tile. In specific embodiments, if a data structure only has a single level (e.g., is not nested), then level size 404 and level size 405 may be zero while level size 403 indicates the size of the single level.

Descriptor 400 describes a set of data structures where each data structure in the set shares a set of characteristics 410. Set of characteristics 410 may include level sizes 403, 404, and 405 as well as data format 406. That is, each data structure in the set of data structures has the same level sizes and data format as the other data structures in the set.

A configuration register (e.g., a descriptor table register) may store descriptor 400. The configuration register can be part of the global register space of a processor. The set of registers can have space for a specified number (e.g., 32) of descriptors. A descriptor can be represented by one or more entries in the configuration register and another descriptor can be represented by one or more entries in the same configuration register or in another configuration register. In specific embodiments, each descriptor can be represented by a 128-bit entry in the global register space.

The configuration register may have independent entries for each descriptors in the set of descriptors. For example, each descriptor in the one or more configuration registers may fill a different quantity of bits, may include different information, and may include different combinations of types of information. For example, a descriptor may describe a data structure with four nested levels. Accordingly, an additional level size section may be stored in the descriptor such that 76 bits are filled rather than the 68 filled bits of descriptor 400 (which describes a data structure with only three nested levels). As another example, a descriptor may refrain from including a buffer limit address such that only 48 bits are filled rather than the 68 filled bits of descriptor 400 (which includes a buffer limit address). In specific embodiments, the limit address field may be set to zero to indicate that the buffer is not a circular buffer. In specific embodiments, a descriptor may include additional information not shown. For example, a descriptor may include a quantity of data structures in the set of data structures that the descriptor describes. A processor may calculate a limit address, if needed, based on the start address, the quantity of data structures, and the size of the data structures (e.g., based on level sizes). In specific embodiments, the information stored in descriptor 400 may be in a different order than the order shown. For example, the level[0] size may be bits 0-7 while the buffer start address may be bits 24-33.

In specific embodiments, each descriptor may be stored in a separate configuration register. In the example of FIG. 4, the configuration register may be 128 bits and the memory storing the data structures may be 4 megabytes. To be able to describe each address in the memory, the descriptor may use 20 bits of start address and 20 bits of limit address. In specific embodiments, there may be an upper range of what data structure size a descriptor can specify using an 8-bit x-dimension, 8-bit y-dimension, and an 8-bit z-dimension format. There may also be a limited number of supported data formats, for example 20 formats, such that 5 bits for specifying a data format may be sufficient. The empty portion of the register may provide configuration register alignment. In specific embodiments, the number of supported data formats, the sizes of the data structure levels, the number of data structure levels, the size of the memory storing the data structures may be different than the example of FIG. 4, such that a larger or smaller number of bits may be used within the descriptor or configuration register. In specific embodiments, the descriptor or configuration register may be a different size (e.g., not 128 bits).

In specific embodiments, descriptors in a processor may all have the same size and format but may include different values in the fields. For example, if a data structure only has a single level (e.g., is not nested), then level size 404 and level size 405 may be zero while level size 403 indicates the size of the single level. As another example, limit address field may be set to zero to indicate that the buffer is not a circular buffer.

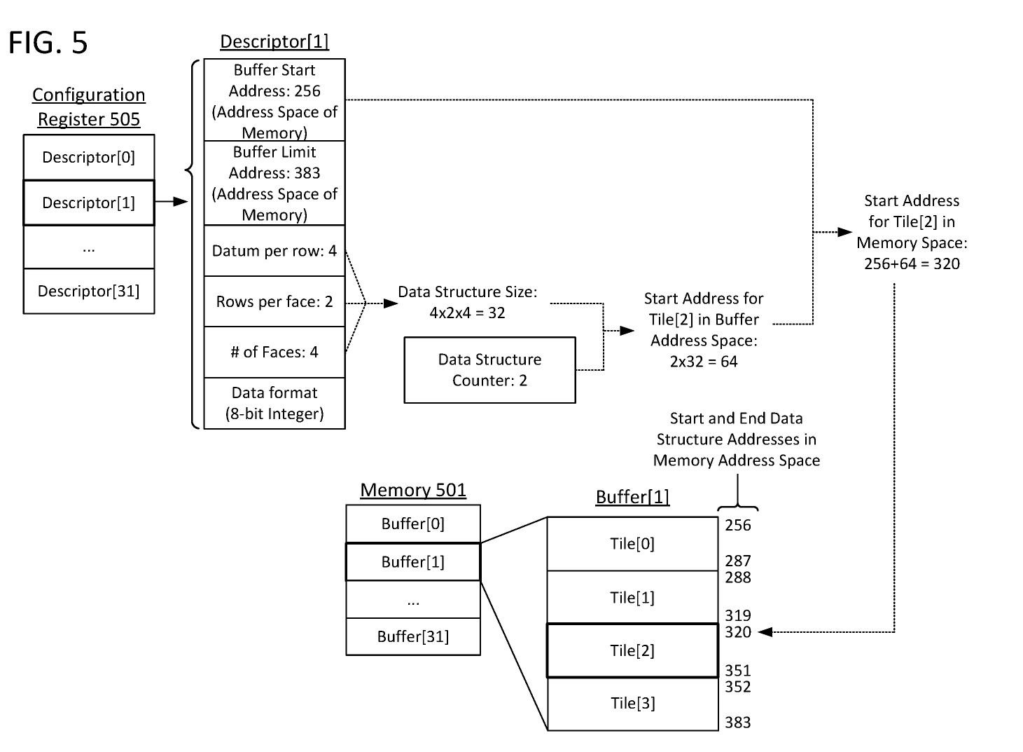

FIG. 5 provides an example of converting an address in the address space of the data structure to an address in the address space of the memory in accordance with specific embodiments of the inventions disclosed herein. In specific embodiments of the invention, specialized circuitry is provided that can execute data manipulation instructions in an instruction set which allow a programmer to access data elements from within a data structure without having to code computations to calculate the address of those data elements, and without the computation layer of the processor needing to be used to calculate the address. Instead, the data elements can be referred to directly in a data manipulation instruction and specialized circuitry can execute the data manipulation instruction to access the desired data elements transparently to the computation layer of the processor. The data manipulation instruction can be an instruction in the instruction set of the processor and can allow for reference to the data element addresses within the syntax of the instruction such that a programmer does not need to code the computations required to calculate the address of the data elements.

Specialized circuitry of the processing core can use the information from the descriptors to automatically calculate the address, in memory, of specific data elements from within the data structures. These computations can be done transparently to the code of the instruction set and the computation layer of the processing core. The specialized circuitry can be designed to access the required information regarding the data structures from the descriptor in the configuration registers and use the information with information provided in the instructions of the instruction set to compute the addresses of the referenced data structures. In specific embodiments, the specialized circuitry can also retrieve the data from the data structures or store data into the data structures.

In specific embodiments, the processor can include circuitry configured to execute an instruction having a syntax that includes an address in an address space of the data structures. The fact that the instruction can refer to the address space of the data structures can alleviate constraints placed on the programmer which are caused by the characteristics of the memory in which the data structures are stored or the manner in which the data structures happen to be stored in the memory at a given time. This can alleviate the burden of programming a computation in that the address space of the data structures is a step closer to the application level of the computation.

In specific embodiments of the invention, execution of the instruction can include using the address in the address space of the data structures and the set of descriptors to calculate an address in the address space of the memory. Since the instruction will refer to the data structure in the address space of the data structures, and the configuration registers (e.g., descriptor table registers) include descriptions of the data structures, the processing core can execute the instruction by using this available information and custom circuitry to calculate the addresses of the data structures in the address space of the memory in order to access the data structures in memory for purposes of executing the instruction. For example, the instruction could be a read instruction and the data could be obtained from memory by first translating from the address space of the data structure to the address space of the memory and then retrieving the data from the address space.

Memory 501 is organized into (e.g., stores) 32 buffers; each buffer stores a set of data structures. In specific embodiments, one or more buffers may be a circular buffer. In the example of FIG. 5, the data structures are tiles. Configuration register 505 stores descriptors that describe characteristics shared by the tiles stored by the corresponding buffer. Memory 501 may be a level one (L1) cache memory. Configuration register 505 (e.g., a descriptor table register) may store descriptors which describe shared characteristics of the corresponding tiles. Descriptor[1] describes the characteristics of each tile within buffer[1]. That is, each tile in buffer[1] has the same quantity of levels, corresponding level sizes, and data format.

Instructions can refer to the data in the address space of the tiles and specialized circuitry may translate the given indexes into the address space of memory 501 using information in a configuration register associated with the set of tiles. For example, an instruction could say: Give me the first element of the next data tile in the set of data tiles in buffer[1]. Buffer[1] may correspond to Descriptor[1]. Descriptor[1] could indicate that each data tile has a size of 32; (4 datum per row) times (2 rows per face) times (4 faces).

A data structure counter may indicate that the next data tile in the set is data tile[2]. For example, the data structure counter may indicate that tile[1] was the last tile to be populated or unpacked. The specialized circuitry may determine the start address of this next data tile by multiplying the data structure counter (2) by the data structure size (32) to get a start address (64) for data tile[2] in the address space of the buffer. This means that tile[2] starts at the memory address 64 of buffer[1]. As determined by descriptor[1], the start address of buffer[1] in memory address space is 256. Adding 64 and 256 together, we get the address of the first element of tile[2] in memory space to be 320.

In specific embodiments, a data element other than the first data element may be referenced by an instruction. For example, to retrieve the fifth data element of tile[2], the specialized circuitry may complete the process above and add four (five minus one). In this case, the fifth element of tile[2] is at memory address 320 + 5 – 1 = 324.

In specific embodiments, the data format may be used to convert an address in data structure space to an address in memory space. For example, if each datum uses two memory addresses, then this may be accounted for in the translation.

In specific embodiments, the instruction set of the processor can include different instructions which can refer to data elements in the tiles at various levels of the tile. For example, the instruction set could include unpack or pack instructions, which retrieve or store one or more datums, rows, or faces. The pack or pack instructions could take in a descriptor index, a tile index, and a face index, and pack or unpack the entire required data unit using the description of the tile and face data structures which are stored at the corresponding descriptor.

In specific embodiments, a data element may be translated from an address space of the data structure to an address space of the memory using the limit address rather than the start address. For example, the specialized circuitry may determine how many data structures are in the buffer (e.g., using the buffer start address, the buffer limit address, and the data structure size) and count backwards from the limit address to find the specific address in memory space of the data requested by the instructions.

In specific embodiments of the invention, an instruction may refer to a specific descriptor that stores a description of the data structure that is being accessed. Accordingly, the processor could use the identification of the descriptor to find that translation between the address space of the data structure and the address space of the memory in which the data elements of the data structure are stored. In specific embodiments, the processor may determine, based on a syntax of the instruction, an address in an address space of the data structure.

In specific embodiments of the invention, the data structures of buffer 102 (including data structure 103) could be tiles that store multiple data elements. The instructions of the instruction set could refer to tiles using names for the tiles. For example, a set of instructions could be: retrieve tile A, retrieve tile B, matrix multiply tile A and B, and store the result in tile C. The processor could be configured to take the address tile “A” and retrieve the tile from memory by translating that address into a set of addresses in the memory using the information in the set of descriptor table registers to compute the set of addresses in the address space of the memory. The execution of the instruction may use the address in the address space of the memory.

The system of FIG. 5 allows a programmer to access any data element (e.g., datum) within a tile without having to code computations to calculate the address of those data elements and without the computation layer of the processor needing to be used to calculate the address. In FIG. 5, the data elements can be referred to directly in an instruction and specialized circuitry can execute the instruction to access the desired data elements transparently to the computation layer of the processor. The instruction can be an instruction in the instruction set of the processor and can allow for reference to the data element addresses within the syntax of the instruction such that a programmer does not need to code the computations required to calculate the address of the data elements. The instruction may have a syntax that includes an address in an address space of the tiles. The execution of the instruction may include using the address in the address space of the tile and the configuration register (e.g., the information stored in the corresponding descriptor in the configuration register) to calculate an address in an address space of the memory.

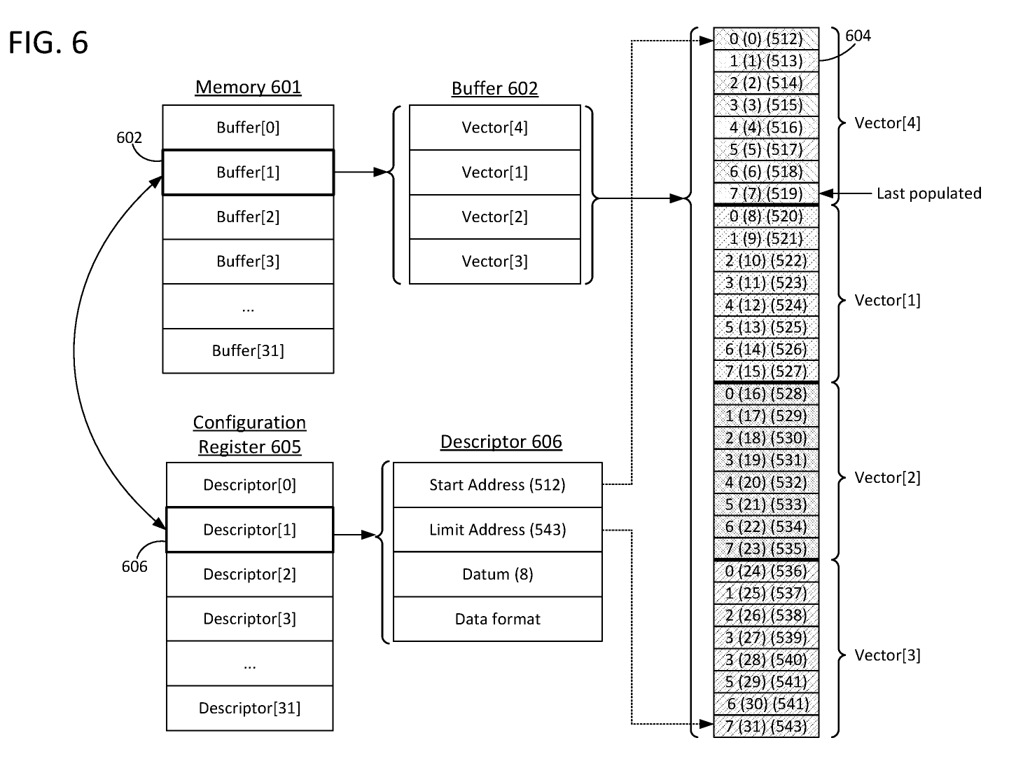

FIG. 6 provides an example of data structures in a circular buffer in accordance with specific embodiments of the inventions disclosed herein. In specific embodiments using a circular buffer, the processor can wrap back to the beginning of the circular buffer if the instruction hits the limit address of the buffer. For example, if a given data structure is referenced in an instruction and the instruction requires more data to be stored than there are free memory addresses until the limit address, the specialized circuitry of the processor can determine that a wrap around is needed by determining the size of the memory needed and comparing it to the size of the remaining memory as defined by the current address and the limit address. The specialized circuitry can then store the additional information in the first/start memory address in the buffer defined by the descriptor. Likewise, the specialized circuitry can determine that data that is requested may be larger than the remaining buffer memory may hold and determine that the remaining addresses allocated for the buffer and a portion of the start of the buffer should be retrieved using similar principles. FIG. 6 shows buffer 602 with each datum 604 having an address in the vector space of the respective vector (first number), an address in buffer space (first number in parenthesis), and an address in memory space (second number in parenthesis).

In the example of FIG. 6, a processor includes memory 601 and configuration register 605. Memory 601 stores a set of buffers including buffer 602. Buffer 602 may be a circular buffer. Configuration register 605 stores a set of descriptors including descriptor 606. Buffer 602 stores Vector[1], Vector[2], Vector[3], and Vector[4]. The start address of buffer 602 is 512 in memory space (0 in data structure space of Vector[4], 0 in buffer space). The limit address of buffer 602 is 543 in memory space (7 in data structure space of Vector[3], 31 in buffer space). The data structures are vectors with one level and eight datum per level. Descriptor 606 stores a set of characteristics of Vectors [1]-[4], a start address of the set of Vectors [1]-[4] (e.g., the start address of buffer 602) in the address space of the memory, and a limit address of the set of Vectors [1]-[4] (e.g., the limit address of buffer 602) in the address space of the memory. The processor (e.g., the NoC) may populate the buffer 602 with the Vector [1], Vector[2], Vector[3], and Vector[4] data structures.

In the example of FIG. 6, addresses 0-7 in the buffer address space may have previously been a Vector[0] but has since been rewritten as Vector[4] as part of the circular nature of the buffer and the workload of the processor. As indicated, the last populated address may be memory address 7 in the buffer address space. The next address to be populated may be address 8 in the buffer address space, which may be populated with the first datum of Vector[5] (not shown).

Unpack instructions may be executed by an unpack engine. The unpacker may consume data structures from the buffer and the NoC may produce the data structures into the buffer. Both the NoC and unpack engine can start from the beginning, reach the end of the buffer, and circle back. The unpack engine may follow close behind the NoC. A hardware mechanism may reset a data structure counter when the limit address is populated or unpacked.

A NoC may start populating data structures from the beginning of the buffer and may continue to populate data from data structures stored in the buffer in order according to memory address. That is, the NoC may start at the start address and move down the buffer, populating the buffer with data structures, until it reaches the limit address. Then, the NoC may loop back to the beginning of the buffer and repopulate the buffer with new data structures in the same way. An unpacker engine (which executes unpack instructions) may follow the NoC as it populates the buffer, consuming the data structures in order according to memory address. The unpack engine may consume the data structures before the NoC repopulates the buffer (e.g., rewrites a new data structure in the memory of an old data structure) such that each data structure is consumed before being written over. In specific embodiments, software may place the NoC in the populating loop and/or the unpack engine in the unpacking loop. Software may issue instructions to process the data structures. The software may not need to keep track of the limit address to tell the NoC or unpack engine to circle back to the beginning of the buffer. Rather, the hardware may keep track of whether the NoC or unpack engine has hit the limit address and automatically wrap the NoC or unpack engine back to the start address of the buffer. Software may initially program the limit address and the start address.

In specific embodiments, a descriptor may refrain from storing a limit address. Instead, the software may determine when to tell the NoC or unpack engine when to wrap back to the beginning of the buffer. As another example, the processor may calculate the limit address using a given number of data structures in the buffer, a start address of the buffer, and a size of each data structure in that buffer. In specific embodiments, the number of tiles in the buffer may change. If the number of data structures in the buffer changes, then the software may update the limit address stored in the configuration register or the number of data structures (if this is stored instead of or in addition to the limit address). Software may have flexibility to decide where to store a buffer in the memory.

Software may update aspects of a descriptor according to workload demands. For example, software may change the region in memory that a descriptor refers to by changing the start and limit addresses. Software may change the size of the described buffer by changing the start and/or limit addresses. Software may change the data format information in the descriptor if a new set of data structures, replacing the old data structures described by a descriptor, use a different data format. Software, via programming a descriptor, may have flexibility to decide where to store a buffer in the memory. The buffers and descriptors may be updated based on the sets of data structures used for a workload.

An unpack tile instruction, executed by an unpack engine, may fetch data from the buffer start address and fetch as much data as the data structure has. The unpack engine may start from the beginning of the buffer and then may perform a number of iterations with the unpack instruction in a loop. In hardware, after the first unpack instruction, there may be an internal counter which keeps track of where the previous instruction stopped fetching its data from this buffer. For example, a buffer may start at address zero and end at address 31 so the limit is reached once the unpack instructions have fetched 32 lines worth of data from the buffer. The next instruction would start at address 32, which is beyond the buffer in this example. Instead, the hardware causes the unpack engine to loops back to address zero.

Hardware may internally keep track of where the previous instruction had finished fetching using one or more internal state registers. Software may be able to manually update these registers to point to specific locations within the buffer for the next instruction to start fetching from. However, a typical mode of operation may be that the software puts the unpack engine in a loop (with the start address and the limit address) and the hardware then automatically unpacks the data structures in order in the buffer, iterating through the buffer one data structure at a time (e.g., data structure[0], then data structure[1], then data structure[2], and so on). At some point, the unpack engine may hit the limit address. As an example, a buffer may have a limit address of 511. If the last unpack tile instruction finished at memory address 511, then the next unpack tile instruction would automatically start at memory address 512. However, the hardware may automatically detect that memory address 512 is beyond the range of this buffer so the hardware may automatically circle back to the beginning of the buffer such that, instead of fetching from address 512, it will fetch from address zero. Software may not have to keep track of whether the unpack engine (or, similarly, the NoC) is hitting the limit of a buffer. Instead, software may set up the loop without having to manage each loop.

Internal state registers may keep track of where the next unpack instruction starts. In specific embodiments, software may jump around within the buffer, populating or unpacking data structures in arbitrary fashion (for example, data structure[4], then data structure[10], then data structure[2]). In these embodiments, the software may manually update the internal state registers that the hardware keeps track of. There may be instructions to manually modify those registers and set them to a specific value such that the unpack engine may then start fetching from the memory address set by the software. In typical use cases, the unpack engine may start at the beginning of the buffer and sequentially iterate through the buffer; and once the unpack engine hits the end, it may circle back to the beginning and without software intervention. Software may program where the limit address is before the unpack engine starts unpacking the buffer, but after the initial programming, software may not need to direct the hardware in terms of consistently checking whether the hardware has hit the limit address of the buffer when the unpack engine iterates through the buffer. Instead, hardware may automatically check the limit address and circle back to the beginning of the buffer as needed. From the programmer’s perspective, the buffer may be an infinite loop where software programs the hardware to start and to kick off a number of iterations of instructions. Each instruction may update the internal state to point to the next tile in the buffer. Hardware may hit the limit, circle back to the beginning of the buffer, and then repeat the processes until an interrupt (or the like) ends the process.

Circular buffer implementation may be especially beneficial when data structures are used in order (e.g., rather than randomly). However, software may perform random access of the data structures within the buffer. In this case, the software may regularly program the hardware (e.g., after every unpack instruction) in order for the hardware to point to the specific desired data structure. That is, if the data structures are not accessed in order, then the software may need to tell the hardware where to fetch the desired data structure.

In specific embodiments, a buffer may not be a circular buffer. Hardware may be designed such that if the limit address is programmed to zero, then there is no circular buffer implementation. The hardware may act as if there isn’t limit to the buffer. If software programs a nonzero value to the limit address, then the hardware mechanism to implement the circular buffer may activate.

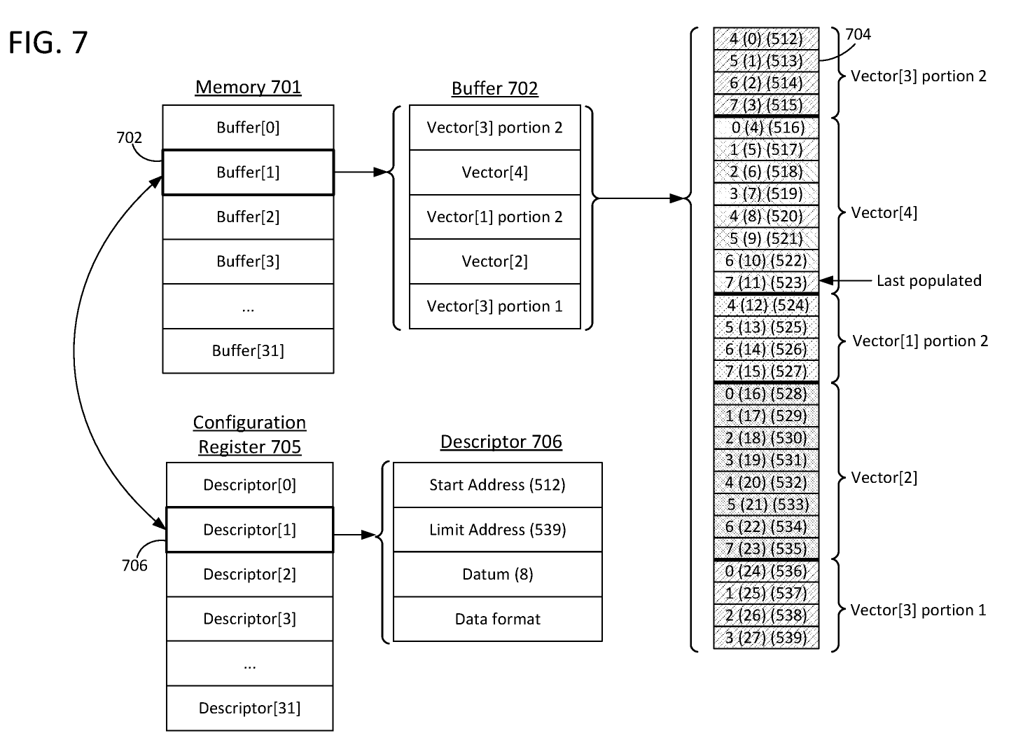

FIG. 7 provides an example of a wrapping a data structure in a circular buffer in accordance with specific embodiments of the inventions disclosed herein. In specific embodiments using a circular buffer, the processor can wrap back to the beginning of the circular buffer if the instruction hits the limit address of the buffer. For example, if a given data structure is referenced in an instruction and the instruction requires more data to be stored than there are free memory addresses until the limit address, the specialized circuitry of the processor can determine that a wrap around is needed by determining the size of the memory needed and comparing it to the size of the remaining memory as defined by the current address and the limit address. The specialized circuitry can then store the additional information in the first/start memory address in the buffer defined by the descriptor. Likewise, the specialized circuitry can determine that data that is requested may be larger than the remaining buffer memory may hold and determine that the remaining addresses allocated for the buffer and a portion of the start of the buffer should be retrieved using similar principles. FIG. 7 shows buffer 702 with each datum 704 having an address in the vector space of the respective vector (first number), an address in buffer space (first number in parenthesis), and an address in memory space (second number in parenthesis).

In the example of FIG. 7, a processor includes memory 701 and configuration register 705. Memory 701 stores a set of buffers including buffer 702. Buffer 702 may be a circular buffer. Configuration register 705 stores a set of descriptors including descriptor 706. Buffer 702 stores Vector[2], Vector[3], and Vector[4], and a part of Vector[1]. The start address of buffer 702 is 512 in memory space (4 in data structure space of Vector[3], 0 in buffer space). The limit address of buffer 702 is 539 in memory space (3 in data structure space of Vector[3], 27 in buffer space). The data structures are vectors with one level and eight datum per level. Descriptor 706 stores a set of characteristics of Vectors [1]-[4], a start address of the set of Vectors [1]-[4] (e.g., the start address of buffer 702) in the address space of the memory, and a limit address of the set of Vectors [1]-[4] (e.g., the limit address of buffer 702) in the address space of the memory. The processor (e.g., the NoC) may populate the buffer 702 with the Vector [1], Vector[2], Vector[3], and Vector[4] data structures.

In the example of FIG. 7, Vector[3] is stored at address 24-27 and 0-3 in the buffer address space. The processor may populate buffer 702 in order. The processor may determine that buffer 702 does not have enough space to contiguously store datum for Vector[3] and may automatically circle back to the beginning of the buffer to store the remaining portion of Vector[3]. Vector[3] may thus be stored non-contiguously with a first portion stored at addresses 24-27 and a second portion stored at addresses 0-3 in buffer space. A datum of Vector[3] may be stored at the limit address and another datum of Vector[3] may be stored at the start address. Hardware may make the determination to loop back to the beginning of the buffer to store the second portion of Vector[3]. In specific embodiments, the determination may be based on the limit address of the buffer, the size of Vector[3], and the start address of Vector[3]. In specific embodiments, hardware may automatically loop back to the beginning of the circular buffer after the limit address is populated. A hardware mechanism may reset a data structure counter when the limit address is populated.

In the example of FIG. 7, buffer 702 may not have enough space to hold four complete vectors. Accordingly, a portion of Vector[1] has been rewritten to be a portion of Vector[4]. The portion of Vector[1] that has not been rewritten (shown in the Figure) may be considered invalid data or may be recognized as a latter portion of a valid vector.

In the example of FIG. 7, addresses 0-7 (in the buffer address space) may have previously been a Vector[0] but has since been rewritten as a second portion of Vector[3] and a first portion Vector[4] as part of the circular nature of the buffer and the demands of the workload. As indicated, the last populated address may be memory address 11 (in the buffer address space). The next address to be populated may be address 12 (in the buffer address), which may be populated with the first datum of Vector[5] (not shown).

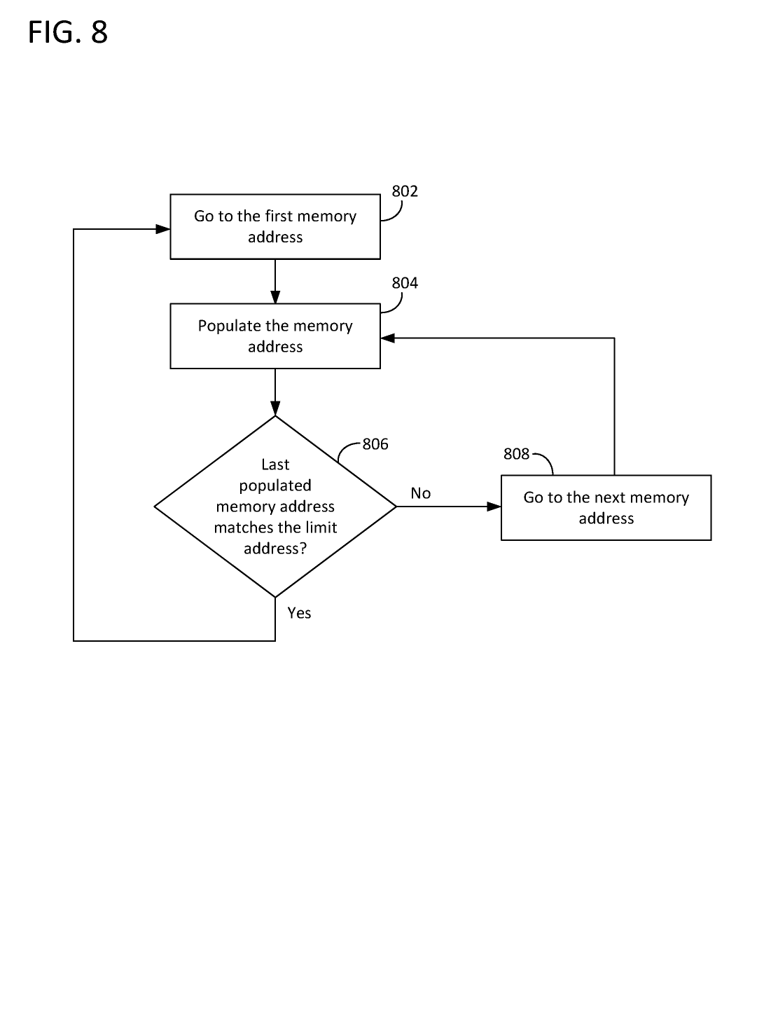

FIG. 8 provides an example of a flowchart for operating a circular buffer in accordance with specific embodiments of the inventions disclosed herein. In specific embodiments using a circular buffer, the processor can wrap back to the beginning of the circular buffer if the instruction hits the limit address of the buffer. For example, if a given data structure requires more data to be stored than there are free memory addresses until the limit address, the specialized circuitry of the processor can then store the additional information in the first/start memory address in the buffer defined by the descriptor and continue populating the buffer from there. Likewise, the specialized circuitry can determine that data that is requested may be larger than the remaining buffer memory and retrieve the remaining portion of the data structure starting back at the start of the buffer. Although FIG. 8 is directed to populating a memory buffer with data structures, a similar flowchart may be used for unpacking data structures. The flowchart of FIG. 8 is an example only, as other methods may be used to implement the circular buffer.

At step 802, a NoC may start at a first memory address (address 0). The memory address may be zero in the memory address space of the data structure and may be any memory address in the address space of the memory. The first (start) memory address may be defined by the descriptor for that buffer. The NoC may start at the first memory address in the sense that the NoC (e.g., or processor) intends to populate, write to, or point at the first memory address.

At step 804, the NoC may populate the memory address with a datum of the data structure. The first time that step 804 iterates, the NoC may populate the first memory address. During subsequent iterations, the NoC may populate other memory addresses. These other memory addresses may be contiguous with, and sequentially after, the first memory address. Eventually, as the NoC circles back to the beginning of the circular buffer, an iteration of step 804 may repopulate the first memory address.

At step 806, hardware may compare the most recently populated memory address (e.g., populated at step 804) with the limit address of the buffer. In specific embodiments, a descriptor may store the limit address of the buffer. The descriptor may store the limit address in the address space of the memory. In specific embodiments, the system may determine the limit address using the start address, the data structure size, and the quantity of data structures. In specific embodiments, software may specify the limit address of the buffer. If the last populated memory address is the same as the limit address, then the system may proceed to step 802. If the last populated memory address is not the same as (e.g., lower than) the limit address, then the system may proceed to step 808.

At step 808, the NoC may shift to the next memory location for the purposes of populating memory. For example, if this is the first iteration of step 808, then the NoC may move to the second memory address (address 1) in the address space of the data structures; the second address may be sequential to the first memory address. If this is the second iteration of step 808, then the NoC may move to the third memory address (address 2). The NoC may move to the next memory address in the sense that the NoC (e.g., or processor) intends to populate, write to, or point at the next memory address. The system may proceed to step 804, in which this “next” memory address is populated.

A NoC may start populating data structures from the beginning of the buffer with data structures and may continue to populate data from data structures stored in the buffer in order according to memory address. The NoC may start at the start address and move down the buffer, populating the buffer with data structures, until it reaches the limit address. Then, the NoC may loop back to the beginning of the buffer and repopulate the buffer with new data structures in the same way. An unpack engine (which executes unpack instructions) may follow the NoC as it populates the buffer, consuming the data structures in order according to memory address. The unpack engine may consume the data structures before the NoC repopulates the buffer (e.g., rewrites a new data structure in the memory of an old data structure) such that each data structure is consumed. In specific embodiments, software may place the NoC in the populating loop and/or the unpack engine in the unpacking loop. Software may issue instructions to process the data structures. The software may not need to keep track of the limit address to tell the NoC or unpack engine to circle back to the beginning of the buffer. Rather, the hardware may keep track of whether the NoC or unpack engine has hit the limit address and automatically wrap the NoC or unpack engine back to the start address of the buffer. Software may initially program the limit address and the start address.

Hardware may internally keep track of where NoC had finished populating using one or more internal state registers. Software may be able to manually update these registers to point to specific locations within the buffer to populate the next data structure. However, a typical mode of operation may be that the software puts the NoC in a loop (with the start address and the limit address) and the hardware then automatically populates the data structures in order in the buffer, iterating through the buffer one data structure at a time. At some point, the NoC may hit the limit address. As an example, a buffer may have a limit address of 511. If the last populate instruction finished at memory address 511, then the next populate instruction would automatically start at memory address 512. However, the hardware may automatically detect that memory address 512 is beyond the range of this buffer so the hardware may automatically circle back to the beginning of the buffer such that, instead of populating address 512, it will fetch from address zero. Software may not have to keep track of whether the NoC is hitting the limit of a buffer. Instead, software may set up the loop without having to manage each loop.

In specific embodiments, a buffer may not be a circular buffer. Hardware may be designed such that if the limit address is programmed to zero, then there is no circular buffer implementation. The hardware may act as if there isn’t limit to the buffer. If software programs a nonzero value to the limit address, then the hardware mechanism to implement the circular buffer may activate.

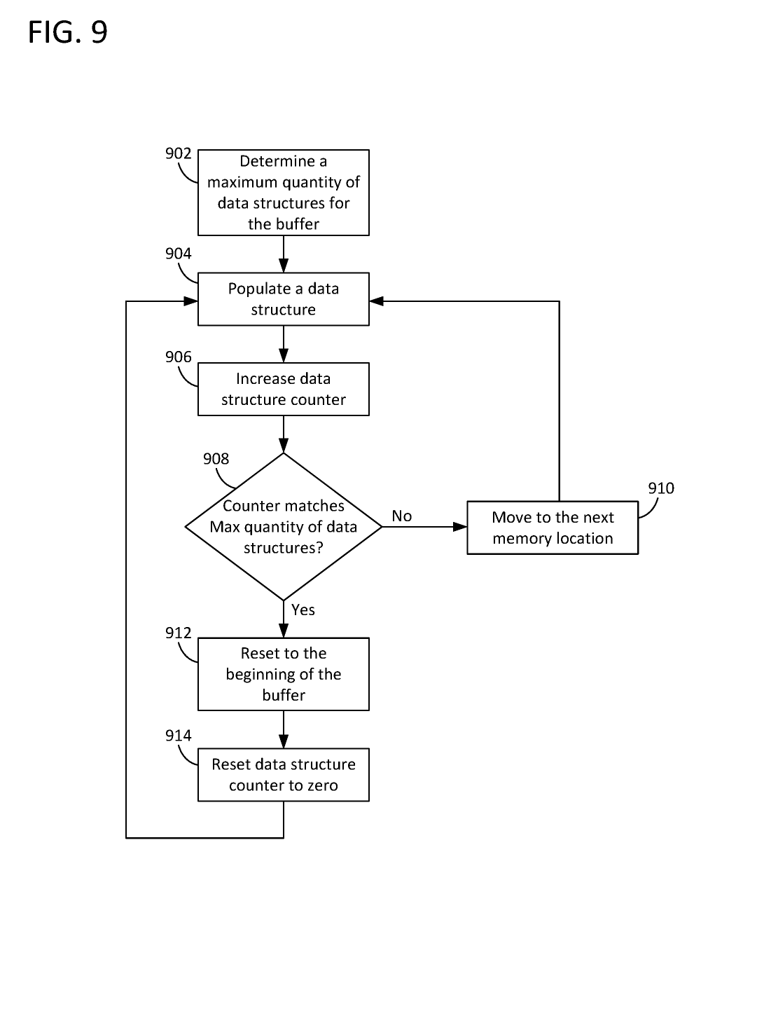

FIG. 9 provides an example of a flowchart for operating a circular buffer using a counter in accordance with specific embodiments of the inventions disclosed herein. In specific embodiments using a circular buffer, the processor can wrap back to the beginning of the circular buffer if the instruction hits the limit address of the buffer. For example, if a given data structure requires more data to be stored than there are free memory addresses until the limit address, the specialized circuitry of the processor can then store the additional information in the first/start memory address in the buffer defined by the descriptor and continue populating the buffer from there. Likewise, the specialized circuitry can determine that data that is requested may be larger than the remaining buffer memory and retrieve the remaining portion of the data structure starting back at the start of the buffer. Although FIG. 9 is directed to populating a memory buffer with data structures, a similar flowchart may be used for unpacking data structures. The flowchart of FIG. 9 is an example only, as other methods may be used to implement the circular buffer.

At step 902, the system may determine a maximum quantity of data structures for the buffer. The maximum quantity of data structures may be the quantity of data structures that fit within the space of the buffer at one time. For example, if a buffer has space for seven data structures of a given size, then the maximum quantity of data structures may be seven. However, the buffer may hold different data structures at different times during a computational process, writing one data structure over another. In specific embodiments, the quantity of data structures that fit within the buffer may be defined by the descriptor for that buffer. In specific embodiments, the quantity of data structures that fit within the buffer may be determined based on information defined by the descriptor for that buffer, such as a buffer start address, a buffer limit address, and a data structure size (e.g., based on data level sizes). In specific embodiments, the quantity of data structures that fit within the buffer may be specified by software.

At step 904, the NoC may populate the buffer with the data structure. The first time that step 904 iterates, the NoC may populate the buffer start memory address (as well as additional memory addresses) with the data structure. During subsequent iterations, the NoC may populate other subsequent contiguous portions of the buffer with subsequent data structures. Eventually, as the NoC circles back to the beginning of the circular buffer, an iteration of step 904 may repopulate the first memory address (as well as additional memory addresses) as part of populating the buffer with another data structure.

At step 906, a data structure counter may be increased. The data structure counter may be implemented by hardware and may count a quantity of data structures populated in the buffer between the buffer start address and the current address.

At step 908, hardware may compare the data structure counter (e.g., incremented at step 906) with the maximum quantity of data structures for the buffer. In specific embodiments, a descriptor may store the quantity of data structures to be put into the buffer. In specific embodiments, the quantity of data structures to be put into the buffer may be calculated by the start address of the buffer, the limit address of the buffer, and a data size of the buffer, which may be stored in the descriptor. In specific embodiments, software may specify the maximum quantity of data structures for the buffer. If the data structure counter is not the same as (e.g., less than) the maximum quantity of data structures, then the system may proceed to step 910. If the data structure counter is the same as the maximum quantity of data structures, then the system may proceed to step 912. The data structure counter being the same as the maximum quantity of data structures may indicate that the limit address of the buffer has been populated.

At step 910, the NoC may shift to the next memory location for the purposes of populating memory. The NoC may move to a memory address that is sequential to the last populated memory address of the previously populated data structure. For example, if this is the first iteration of step 910 and the last populated memory address of the first data structure is memory address 127, then the NoC may move to memory address 128. If this is the second iteration of step 910, then the NoC may move to memory address 256. The NoC may move to the next memory address in the sense that the NoC (e.g., or processor) intends to populate, write to, or point at the next memory address. The system may proceed to step 904, in which this “next” memory address, as well as additional memory addresses for the data structure, are populated.

At step 912, a NoC may reset back to, or move to, the first memory address (address 0). The next data structure that populates may be written over a previous data structure. The NoC may move back to the first memory address in the buffer automatically (e.g., without software intervention).

At step 914, the data structure counter may be reset to zero. The counter may be reset to zero as, in this iteration of populating the buffer, there are not yet any new data structures written in the buffer. The data structure counter may be reset automatically by a hardware mechanism.

A NoC may start populating the beginning of the buffer with data structures and may continue to populate the buffer with subsequent data structures in order according to memory address. The NoC may start at the start address and move down the buffer, populating the buffer with data structures, until it reaches the limit address. Then, the NoC may loop back to the beginning of the buffer and repopulate the buffer with new data structures in the same way. An unpacker engine (which executes unpack instructions) may follow the NoC as it populates the buffer, consuming the data structures in order according to memory address. The unpack engine may consume the data structures before the NoC repopulates the buffer (e.g., rewrites a new data structure in the memory of an old data structure) such that each data structure is consumed. In specific embodiments, software may place the NoC in the populating loop and/or the unpack engine in the unpacking loop. Software may issue instructions to process the data structures. The software may not need to keep track of the limit address to tell the NoC or unpack engine to circle back to the beginning of the buffer. Rather, the hardware may keep track of whether the NoC or unpack engine has hit the limit address and automatically wrap the NoC or unpack engine back to the start address of the buffer. Software may initially program the limit address and the start address.

Hardware may internally keep track of where the NoC had finished populating using one or more internal state registers. Software may be able to manually update these registers to point to specific locations within the buffer to populate the next data structure. However, a typical mode of operation may be that the software puts the NoC in a loop (with the start address and the limit address) and the hardware then automatically populates the data structures in order in the buffer, iterating through the buffer one data structure at a time (e.g., populate data structure[0], then data structure[1], until data structure[n]). At some point, the NoC may hit the maximum quantity of data structures (of a given size) that fit within the buffer. A data structure counter in the hardware may increment each time a data structure is populated. As an example, a buffer may have a limit address of 511 and data structures that are each 64-bits such that the buffer can fit eight data structures. If a data structure counter indicates that eight data structures have been written, then the next populate instruction, which would have automatically started at memory address 512, may instead start at memory address zero. The hardware may automatically detect that a nineth data structure would not fit within the buffer (that memory address 512 is beyond the range of this buffer) so the hardware may automatically circle back to the beginning of the buffer such that, instead of populating address 512, it will populate address zero. Software may not have to keep track of whether the NoC is hitting the limit of a buffer. Instead, software may set up the loop without having to manage each loop.

An unpack instruction, executed by an unpack engine, may fetch data from the buffer start address and fetch as much data as the data structure has. The unpack engine may start from the beginning of the buffer and then may perform a number of iterations with the unpack instruction in a loop. In hardware, after the first unpack instruction, there may be an internal counter which keeps track of where the previous instruction stopped fetching its data from this buffer. For example, a buffer may start at address zero and end at address 63 so the limit is reached once the unpack instructions have fetched 64 lines worth of data from the buffer; 64 lines of data may correspond to multiple data structures. The next instruction would start at address 64, which is beyond the buffer in this example. Instead, the hardware causes the unpack engine to loops back to address zero.

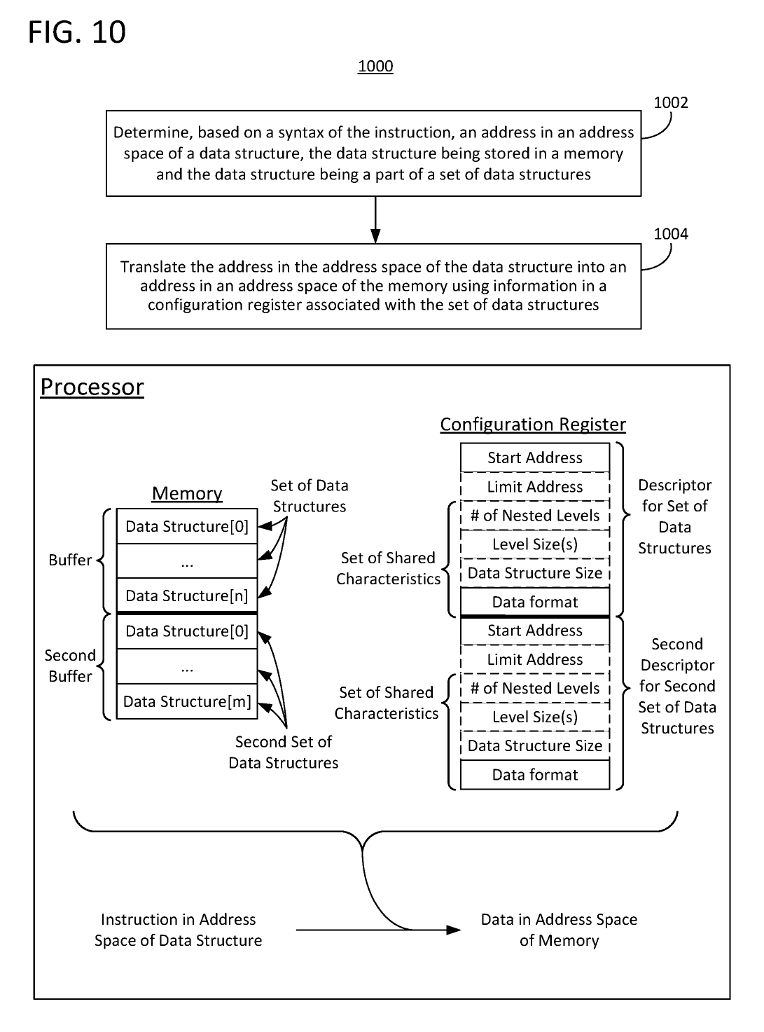

FIG. 10 provides an example of method 1000 for executing an instruction using a descriptor in accordance with specific embodiments of the inventions disclosed herein. Method 1000 may be implemented by a system including a set of data structures stored in a memory, a configuration register, and circuitry configured to execute an instruction. In specific embodiments, the system may also include additional sets of data structures. Method 1000 may be implemented by a system including means for performing the steps of method 1000. Steps, or portions of steps, of method 1000 may be duplicated, omitted, rearranged, or otherwise deviate from the form shown. Additional steps may be added to method 1000. In specific embodiments, various steps, or portions of steps, of method 1000 may be performed in series or parallel.

At step 1002, an address in an address space of a data structure may be determined based on a syntax of the instruction. The data structure may be stored in a memory and the data structure may be a part of a set of data structures. In specific embodiments, the set of data structures may be a set of nested data structures with two or more nested levels. Each data structure in the set of nested data structures may have the same quantity of elements at each nested level as the other data structures in the set of nested data structures. In specific embodiments, the data structures in the set of data structures may be tiles or tensors. In specific embodiments, the set of data structures may be stored in a buffer in the memory. In specific embodiments, the buffer may be a circular buffer. In specific embodiments, the memory may be a level one cache memory.

At step 1004, the address in the address space of the data structure may be translated into an address in an address space of the memory using information in a configuration register associated with the set of data structures. In specific embodiments, the configuration register may store a start address, in the address space of the memory, of the buffer. The start address of the buffer may be the start address of the set of data structures. In specific embodiments, the configuration register may store a limit address, of the set of data structures, in the address space of the memory. In specific embodiments, the configuration register may store information indicative of a set of characteristics that are shared by each data structure in the set of data structures. In specific embodiments, the set of characteristics may comprise a data format of datums of the data structures, a quantity of nested levels in the data structure, and a size of each nested level in the data structure. In specific embodiments, the configuration register may store information indicative of a quantity of elements in each data structure of the set of data structures. In specific embodiments, the configuration register may store an indicator of the quantity of elements at each nested level for each nested level of the set of nested data structures.

In specific embodiments, the instruction may be executed using the address in the address space of the memory. In specific embodiments, execution of the instruction may include using the address in the address space of the data structures and the configuration register to calculate the address in the address space of the memory. Circuitry may be configured to execute the instruction. In specific embodiments, the processor (e.g., NoC) may populate the memory with the set of data structures. A hardware mechanism may reset a data structure counter when the limit address is populated.

In specific embodiments, a portion of the configuration register is a descriptor. The descriptor may store the set of characteristics of the set of data structures, a start address of the set of data structures in the address space of the memory, and a limit address of the set of data structures in the address space of the memory. A first portion of a data structure in the set of data structures may be stored at the limit address and a second portion of the data structure may be stored at the start address.

In specific embodiments, a second set of data structures may be stored in the memory. The configuration register may store a second set of characteristics of the second set of data structures. The circuitry may further be configured to execute a second instruction having a syntax that includes an address in an address space of the second set of data structures. Execution of the second instruction may include using the address in the address space of the second set of data structures and the second set of characteristics to calculate a second address in the address space of the memory. In specific embodiments, the set of characteristics of the set of data structures may be different than the second set of characteristics of the second set of data structures. In specific embodiments, the set of data structures correspond to a first address range in the memory, the first address range having a first size. The second set of data structures may correspond to a second address range in the memory, the second address range having a second size. The first size may be different than the second size.

In the context of processor design, programmers typically must manually calculate memory addresses of data elements within data structures, requiring complex arithmetic operations and pointer manipulation that account for factors like starting addresses, element sizes, and alignment requirements. This address calculation process is cumbersome and error-prone, especially with complex nested data structures, and can lead to bugs such as accessing wrong memory locations, causing unpredictable behavior or program crashes. Calculations in the computation layer of the processor place significant burden on programmers to write and maintain code for precise address computation, increasing development complexity and time. The inventions disclosed herein allow programmers to access data elements from within data structures without having to code computations to calculate addresses of those data elements, and without requiring the computation layer of the processor to calculate the addresses.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed is:

1. A processor defined by an instruction set including an instruction and comprising:
a set of data structures stored in a memory;
a configuration register storing a set of characteristics of the set of data structures; and
circuitry configured to execute the instruction having a syntax that includes an address in an address space of the data structures;
wherein execution of the instruction includes using the address in the address space of the data structures and the configuration register to calculate an address in an address space of the memory.

2. The processor of claim 1, wherein the configuration register stores:
a start address of the set of data structures in the address space of the memory; and
a data format of datums of the set of data structures.

3. The processor of claim 1, wherein the configuration register stores:
information indicative of a quantity of elements in each data structure of the set of data structures.

4. The processor of claim 1, wherein the configuration register stores:
a limit address, of the set of data structures, in the address space of the memory.

5. The processor of claim 4, wherein:
the memory is a circular buffer;
the processor populates the memory with the set of data structures; and
a hardware mechanism resets a data structure counter when the limit address is populated.

6. The processor of claim 1, wherein:
the set of data structures is a set of nested data structures with two or more nested levels;
each data structure in the set of nested data structures has the same quantity of elements at each nested level as the other data structures in the set of nested data structures; and
the configuration register stores an indicator of the quantity of elements at each nested level for each nested level of the set of nested data structures.

7. The processor of claim 1, wherein:
the set of data structures are stored in a circular buffer of the memory;
a portion of the configuration register is a descriptor;
the descriptor stores the set of characteristics of the set of data structures, a start address of the set of data structures in the address space of the memory, and a limit address of the set of data structures in the address space of the memory;
a first portion of a data structure in the set of data structures is stored at the limit address; and
a second portion of the data structure is stored at the start address.

8. The processor of claim 1, further comprising:
a second set of data structures stored in the memory;
wherein: (i) the configuration register stores a second set of characteristics of the second set of data structures; (ii) the circuitry is further configured to execute a second instruction having a syntax that includes an address in an address space of the second set of data structures; and (iii) execution of the second instruction includes using the address in the address space of the second set of data structures and the second set of characteristics to calculate a second address in the address space of the memory.

9. The processor of claim 8, wherein the set of characteristics of the set of data structures are different than the second set of characteristics of the second set of data structures.

10. The processor of claim 8, wherein:
the set of data structures correspond to a first address range in the memory;
the first address range has a first size;
the second set of data structures correspond to a second address range in the memory;
the second address range has a second size; and
the first size is different than the second size.

11. The processor of claim 1, wherein the memory is a level one cache memory.

12. The processor of claim 1 wherein the data structures in the set of data structures are tiles or tensors.

13. A method for executing an instruction, using a processor, comprising:
determining, based on a syntax of the instruction, an address in an address space of a data structure, the data structure being stored in a memory and the data structure being a part of a set of data structures; and
translating the address in the address space of the data structure into an address in an address space of the memory using information in a configuration register associated with the set of data structures;
wherein the execution of the instruction uses the address in the address space of the memory.

14. The method of claim 13, wherein:
the set of data structures are stored in a buffer in the memory; and
the configuration register stores a start address, in the address space of the memory, of the buffer.

15. The method of claim 13, wherein the configuration register stores:
information indicative of a set of characteristics that are shared by each data structure in the set of data structures; and
a start address of the set of data structures in the address space of the memory.

16. The method of claim 15, wherein the set of characteristics comprises:
a data format of datums of the data structures;
a quantity of nested levels in the data structure; and
a size of each nested level in the data structure.

17. The method of claim 13, wherein the configuration register stores a limit address, of the set of data structures, in the address space of the memory.

18. A processor, defined by an instruction set including an instruction, comprising:
a memory organized into a set of buffers, each buffer storing a set of data structures, wherein a set of characteristics are the same for each data structure in the set of data structures;
a configuration register wherein the configuration register stores a set of descriptors and each descriptor in the set of descriptors: (i) corresponds to a buffer in the set of buffers; and (ii) stores information indicative of the set of characteristics of the set of data structures of the corresponding buffer; and
circuitry configured to execute the instruction, using the information, to thereby translate an address in an address space of the set of data structures into an address in an address space of the memory.

19. The processor of claim 18, wherein each descriptor stores a start address, in the address space of the memory, of the corresponding buffer.

20. The processor of claim 18, wherein the set of characteristics comprises:
a data format of datums in each data structure in the set of data structures;
a quantity of nested levels in each data structure in the set of data structures; and
a size of each nested level in each data structure in the set of data structures.
